(19) United States
(12) Patent Application Publication
(10) Pub. No.: US 2005/0093414 A1
(43) Pub. Date: May 5, 2005

(54) Glass sealed spark plug assembly

(75) Inventors: Darren C. Downs, Northwood, OH (US); Robert D. Freeman, Monclova, OH (US); Lawrence W. Geer, Waterville, OH (US); Thomas Nohl, Holland, OH (US)

Correspondence Address: JAMES D. STEVENS;REISING, ETHINGTON, BARNES, KISSELLE, P.C., P.O. BOX 4390, TROY, MI, 48099, US

(73) Assignee: Federal-Mogul World Wide, Inc., Southfield, MI (US)

(21) Appl. No.: 10/702,380

(22) Filed: Nov. 5, 2003

(51) Int. Cl. H01T 13/20

(52) U.S. Cl. 313/141; 313/137

(57) ABSTRACT

A spark plug includes an electrode which during assembly is inserted into a vertical bore of a ceramic insulator from beneath. The electrode has an expanded firing end protruding from the insulator bottom. Tabs at an upper end of the electrode are expanded inside the bore to engage the insulator, and this is done using a removable expanding tool inserted into the insulator. A conductive glass in granular form is poured into the bore and envelops the expanded upper end of the electrode. A sacrificial conductive push pin inserts into the upper bore over the glass granules. The sub-assembly is heated to melt the glass and the push pin is pressed down into the melted glass. Upon cooling, the glass within the insulator fuses forming a seal which further strengthens the flared engagement of the electrode to the insulator.

### TECHNICAL FIELD

The present invention relates generally to spark plugs, and more particularly, to the center electrode assemblies used in glass seal spark plugs.

### BACKGROUND OF THE INVENTION

The spark plugs of an engine are directly exposed to high temperature condition and pressure transients of a combustion chamber. For this reason the spark plug should have gas tight sealant qualities to prevent loss of combustion pressure and degradation of the electrical continuity of the spark plug. To complicate matters, the spark plug is situated within an environment that creates temperature fluctuations in excess of 600° F. One avenue of gas leakage through the spark plug is via the central bore through the longitudinal length of the insulator. It is common to use a non-expanding glass seal and in some instances, a conductive glass seal to prevent leakage through the bore. The conductive glass seal is in contact with not only the bore wall but also other conductive members of the center electrode assembly. For this reason, axial movement or thermal expansion of the electrode assembly can lead to breakage of the glass seal thereby losing the gas tight characteristic of the spark plug.

### SUMMARY OF THE INVENTION

The present invention provides a spark plug having an insulator which extends between top and bottom ends. An upper portion of the insulator carries the top end and extends axially to a bottom portion of the insulator at an intermediate location from which the bottom portion projects further to the bottom end. An electrode inserts into a lower bore of the lower portion through a bottom end of the lower portion. An enlarged firing end of the electrode protrudes from the insulator and engages the bottom end preventing upward movement of the electrode. An expanded upper end of the electrode engages a shoulder of the insulator at the intermediate location formed by the difference in diameters of an upper bore of the upper portion and the smaller diameter of the lower bore. The upper end is expanded to engage the shoulder and prevent downward movement of the electrode by an expanding tool which inserts into the upper bore of the upper portion.

Preferably, the expanded upper end of the electrode is located in place using a conductive glass seal. The seal can be made by pouring conductive glass powder into the insulator through the upper bore enveloping the expanded upper end of the electrode. A sacrificial push pin inserts into the upper bore over the glass granules. Preferably, a removable push rod tool inserts over the push pin. The resultant electrode assembly is heated to melt the glass. During cooling, the glass is fused under the pressure of the push rod tool to thereby form a conductive seal. The push rod tool is removed and final assembly of the spark plug can then be completed, which may include adding one or more suppressive devices and a compression spring along with a terminal, as well as attaching a metal shell circumferentially about at least a portion of the insulator.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a longitudinal cross-sectional view of a spark plug;

FIG. 2 is a partial exploded cross-sectional view of the spark plug;

FIG. 3 is an enlarged cross-sectional view of an electrode;

FIG. 4 is an enlarged cross-sectional view of the spark plug taken along lines 4-4 viewing in the direction of the arrows found in FIG. 1, but prior to plastic deformation of a plurality of tabs of the electrode;

FIG. 5 is the same cross-sectional view of FIG. 4, but after plastic deformation of the plurality of tabs of the electrode;

FIG. 6 is a perspective view of an expanding tool; and

FIG. 7 is a perspective view of a push rod tool.

### DETAILED DESCRIPTION OF THE PREFERRED EMBODIMENTS

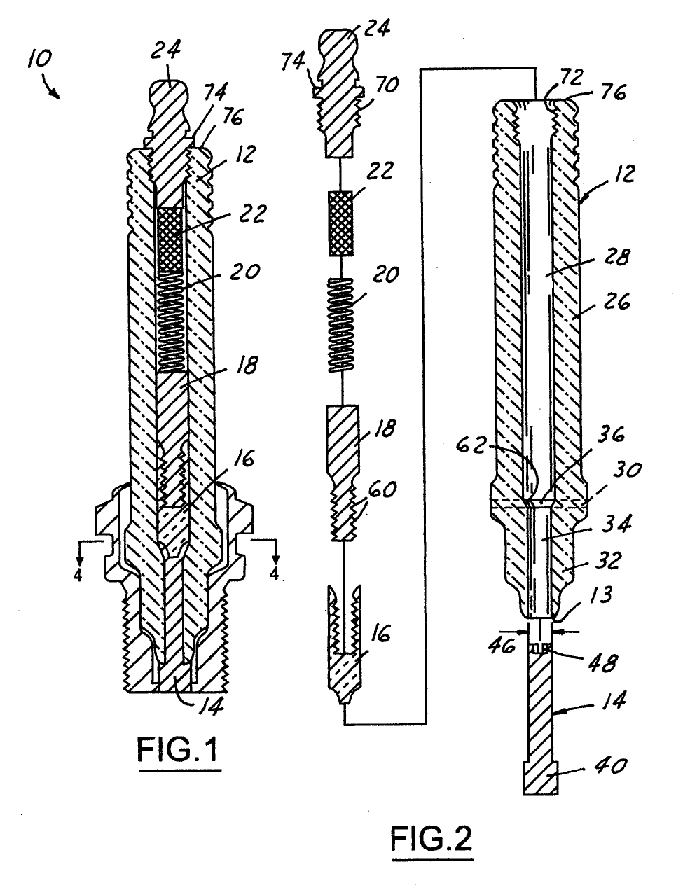

Referring first to FIG. 1, there is shown a spark plug 10 having an electrode 14 which axially penetrates a bottom surface 13 of an elongated insulator 12 of the spark plug 10. Sequentially stacked axially above the electrode 14, and oriented concentrically within the insulator 12 is a seal 16, a push pin 18, a spring 20, a suppressor 22, and a terminal 24. Use of the suppressor 22 is optional but preferred because it reduces radio frequency interference, and can take the form of a wire wound conductor or resistor. The spark plug 10 has an exterior metallic shell 25 for engaging an engine block or head (not shown). The metallic shell 25 circumscribes and engages a portion of the insulator 12 and has a threaded portion for engaging the engine head and a generally hexagonal portion for engagement of a tool (not shown) for rotational installation and removal of the spark plug 10 from the engine.

Referring to FIG. 2, the insulator 12, has an upper portion 26 defining an axially extending upper bore 28 and a substantially concentric lower portion 32 which defines an axially extending lower bore 34. The upper and lower portions 26, 32 engage substantially concentrically at an axially intermediate location 30. Because the upper bore 28 has a greater diameter than the lower bore 34 the insulator 12 carries a shoulder 36 substantially annular in shape, at the intermediate location 30.

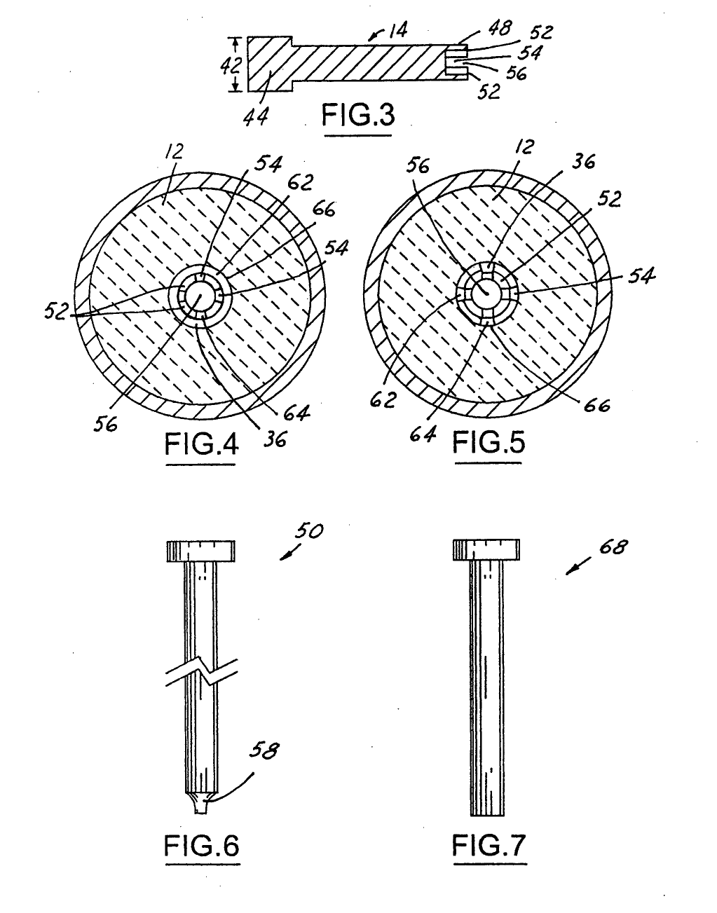

The electrode 14 inserts into the lower portion 32 of the insulator 12, through the bottom end 13 of the lower portion 32 which like the shoulder 36 is also substantially annular in shape. The upward insertion of the electrode 14 ceases when an enlarged head or substantially cylindrical firing end 40 of the electrode 14 engages the bottom end 13. The mechanical engagement of firing end 40 with bottom end 13 is appreciable in order to resist the upward combustion forces exerted upon the electrode 14 and occurring within the combustion cylinder of an engine. Thus, a diametric length 42 of the firing end 40 measured laterally with respect to the elongated insulator 12, is appreciably greater than a diameter 46 of the lower bore 34, as best shown in FIGS. 2 and 3.

When electrode 14 inserts fully into the insulator 12, an upper end 48 of electrode 14 aligns axially to the shoulder 36. Preventing any subsequent downward movement of the electrode 14 with respect to the insulator 12, the upper end 48 expands radially outward to engage the shoulder 36 at the intermediate location 30. This engagement is preferably achieved by plastic deformation and radial expansion of the upper end 48 though use of a removeable expanding tool 50, as shown in FIG. 6. The expanding tool 50 inserts into the insulator 12 from above through the upper bore 28 where tool 50 then makes contact with and deforms the upper end 48 of the electrode 14.

The electrode 14 is made of a conductive metallic material, and the insulator 12 is generally made of a heat resistant ceramic material. When flaring the upper end 48 of electrode 14 radially outward, care should be taken so as not to produce excessive stresses which could cause insulator 12 to crack. To assure that the insulator 12 does not crack, the upper end 48 has a substantially reduced cross sectional area with respect to the remainder of the electrode and is composed of at least one axially extending tab 52 prior to bending. The cross section of tab 52 is thereby sized to permit easy bending or flaring out within the upper bore 28 to make contact with the shoulder 36 at the intermediate location 30.

Referring now to FIGS. 4 and 5, the upper end 48 comprises a plurality of annularly-spaced tabs 52 divided by a plurality of longitudinally extending slots 54. The plurality of tabs 52 together define a central bore 56 and are equally spaced circumferentially about the central bore 56 of the electrode 14. The symmetric placement of tabs 52 assist the expanding tool 50 in deforming the tabs 52 without risking breakage of insulator 12. Tabs 52 restrict and guide expanding tool 50 in the axial direction only, thereby preventing lateral or radial movement of expanding tool 50 which could potentially crack insulator 12. To guide expanding tool 50 into the central bore 56, tool 50 has a beveled end 58 wherein the beveled radius shapes the deformation of tabs 52 against the shoulder 36 of the insulator 12.

Although the shoulder 36 at the intermediate location 30 may take a variety of forms, it preferably has a substantially annular surface 62 which directly contacts the flared tabs 52. An inner perimeter 64 of annular surface 62 aligns radially to or congruently forms into the circumference of the lower bore 34. Likewise, an outer perimeter 66 of annular surface 62 congruently forms into the circumference of the upper bore 28. This radial alignment to the upper bore 28, however, is not required but does simplify the manufacturing process. If manufactured as such, the diameter of the upper bore 28 is greater than the diameter of the lower bore 34. Moreover, with use of the annular surface 62 of insulator 12, the plurality of symmetrically spaced tabs 52 of electrode 14, the annular bottom end 13 of insulator 12, and the conical firing end 40 of electrode 14, the electrode 14 need not be aligned circumferentially to the insulator 12 when inserted.

After bending of tabs 52, the electrode 14 is rigid and will not move axially, up or down, with respect to the insulator 12 regardless of forces applied to spark plug 10. It is thus interlocked mechanically to the insulator 12 by the enlarged firing end 40 and the expanded tabs 52. Prior to further assembly of spark plug 10, the expanding tool 50 is removed from above insulator 12.

Referring to FIGS. 1 and 2, the seal 16 seals directly to the lower portion 32 of the insulator 12, to the push pin 18, and to the electrode 14. Seal 16 also provides the conductive pathway between the push pin 18 and the electrode 14. To further strengthen the vertical hold of upper end 48 of electrode 14 and enhance electrical conductivity, the seal 16 generally extends into the slots 54 between the bent tabs 52. Seal 16 may have several distinctive layers stacked axially within the insulator 12 which may be preferable depending upon the electrical engagement characteristics of the materials forming electrode 14 and the push pin 18, and/or the functional requirements of seal 16. For instance, a center seal layer composed of glass and carbon may be used as a resistor to suppress high frequency interference. An upper and lower layer of seal 16 could then be used to reliably complete the necessary conductive path between the push pin 18, and the electrode 14. Where seal 16 includes the resistive characteristics of a carbon mixture, locating suppressor 22 between the terminal 24 and the spring 20 may not be necessary. However, the suppressor 22 may be preferred over the use of a resistive carbon glass seal in applications where the high temperatures from the engine combined with the heat created by the ignition energy might otherwise break down the resistive carbon glass.

Preferably, the suppressor 22 is as shown in FIG. 1, and the seal 16 functions electrically as a conductor. This conductor may take the form of a wire extending through seal 16 in which case non-conductive glass can be used for the remaining portion of the seal 16. However, and preferably, seal 16 is made of a conductive glass material having metallic traces, such as copper, nickel, or silver, running integral and throughout the composition of the seal 16. Glass is a desirable seal for a spark plug 10 environment because of glass' high temperature resistance and non-expanding characteristics. During assembly of spark plug 10, a pre-determined amount of glass granules or powder, which ultimately become glass seal 16 after heating, is poured into the upper and lower bores 28, 32 from above, enveloping the tabs 52 at the intermediate location 30.

After pouring of the glass granules, the push pin 18 inserts from above, followed by a push rod tool 68. This sub-assembly is then placed within a heat source. The glass granules have a melting point temperature which is lower than the electrode 14, the push pin 18, the insulator 12 and the push rod tool 68. Upon melting of the glass granules, the sub-assembly is removed from the heat source. A press device then exerts a downward force upon the heated push rod tool 68, pushing the push pin 18 into the now liquid glass and to a predetermined axial location within the upper bore 28. Heating of push rod tool 68 along with the assembly minimizes thermal shock to the assembly during the pressing process.

The firing end of push pin 18 has a series of ribs 60 extending circumferentially about the push pin 18 and spaced axially apart from one another with respect to the elongated insulator 12. The liquid glass, envelops the ribs 60 with the downward exertion of push rod tool 68. The envelopment provides superior adhesion, assisting in a reliable seal to the push pin 18 which expands and contracts with temperature. The push rod tool 68 further urges the liquid glass to flow between the tabs 52 into the slots 54 of the electrode 14 strengthening the tab 52 engagement with the shoulder 36 and enhancing the conductive pathway.

Once the glass has hardened or fused to form the glass seal 16 between the electrode 14, the insulator 12, and the push pin 18, the once heated push rod tool 68 is removed from above the insulator 12. The spring 20 followed by the optional suppressor 22 is then inserted into the insulator 12 from above, both residing within the upper bore 28 and both being conductive.

The terminal 24 has threads 70 which threadably mate to threads 72 of the insulator 12 to secure the remainder of the spark plug 10 axially together. During assembly or threading of the terminal 24 to the insulator 12 the terminal 24 moves axially downward making electrical contact with the suppressor 22 and compressing the spring 20. The compression of spring 20 assures electrical continuity and accounts for vertical heat expansion from the terminal 24 through the push pin 18. Rotation or threading of the terminal 24 to the insulator 12 within the upper bore 28 ceases when a radially projecting flange 74 of the terminal 24 engages a substantially annular top end 76 of the insulator 12.

Accordingly, it should thus be apparent that the present invention provides a spark plug assembly having superior sealing qualities which can better resist expansion and contraction caused by temperature fluctuations, and better resist external axial forces applied to the electrode in either axial direction. It will of course be understood that the foregoing description is of preferred exemplary embodiments and that the invention is not limited to the specific embodiments shown. Various changes and modifications will become apparent to those skilled in the art. For example, the upper end 48 of the electrode 14 can be pre-expanded, wherein the electrode inserts into the insulator 12 from above, not below. It may then be the firing end 40 which is flared radially outward to prevent axial movement of the electrode 14 with respect to the insulator 12. All such changes and modifications are intended to come within the scope of the appended claims.

As used in this specification and appended claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A spark plug comprising:
an insulator extending from a top end of the insulator to a bottom end of the insulator and having upper and lower portions separated at a location intermediate the top and bottom ends, the upper portion defining an upper bore, the lower portion defining a lower bore, the upper bore in axial communication to the lower bore, with the insulator having an upwardly exposed shoulder at the intermediate location;
a metal shell disposed about at least a portion of the insulator; and
an electrode extending through the lower bore, the electrode having an enlarged firing end contacting the bottom end of the insulator preventing upward movement of the electrode with respect to the insulator, the electrode further having an expanded upper end in contact with the shoulder at the intermediate location preventing downward movement of the electrode with respect to the insulator.

2. A spark plug as set forth in claim 1, wherein the bottom end is annular and the firing end has a length orthogonal to the lower bore, the length greater than a diameter of the lower bore.

3. A spark plug as set forth in claim 1, wherein the shoulder carries an inner annular surface having an outer perimeter and an inner perimeter, the inner perimeter radially aligned to the circumference of the lower bore.

4. A spark plug as set forth in claim 3, wherein the upper end of the electrode has at least one holding tab which extends radially outward and engages the inner annular surface.

5. A spark plug as set forth in claim 3, wherein the upper end of the electrode has a plurality of annularly-spaced holding tabs separated by a plurality of slots, the tabs together defining a center bore aligned axially with the upper bore, the tabs being symmetrically spaced about the center bore, the tabs extending radially outward engaging the inner annular surface.

6. A spark plug as set forth in claim 5, wherein the firing end is an enlarged cylindrical head disposed concentrically to the lower bore.

7. A spark plug as set forth in claim 6, further comprising a conductive glass seal in the upper bore in contact with the upper end of the electrode such that the glass seal extends into the center bore and into the slots.

8. A spark plug as set forth in claim 1, further comprising a push pin disposed above and in electrical communication with the electrode, the push pin disposed within the upper bore.

9. A spark plug as set forth in claim 8, further comprising a seal engaged between the push pin and the electrode.

10. A spark plug as set forth in claim 9, wherein the seal is an electrically conductive non-expanding glass.

11. A spark plug as set forth in claim 10, wherein the push pin has a plurality of ribs disposed axially along the push pin, each rib extending circumferentially about the push pin, the ribs engaged to the seal.

12. A spark plug as set forth in claim 10, further comprising:
a terminal exposed above the insulator and engaged threadably to the insulator within the upper bore;
a suppressor disposed within the upper bore and beneath the terminal; and
a spring disposed in compression within the upper bore between the suppressor and the push pin.

13. A spark plug as set forth in claim 1, wherein the upper end of the electrode includes a plurality of holding tabs bent outwardly and in engagement with the shoulder, and wherein the spark plug further comprises a glass seal in a lower section of the upper bore, the glass seal extending between the tabs so as to lock them in place against the shoulder.

14. A method assembling center electrode components in a spark plug insulator comprising the steps of:
inserting an upper end of an electrode through an annular bottom end of an insulator and upward into a lower bore of a lower portion of the insulator;
engaging a firing end of the electrode to the annular bottom end thereby preventing further upward movement of the electrode with respect to the insulator;
inserting an expanding tool downward through an upper bore of an upper portion of the insulator;
contacting a tip of the expanding tool against inward sides of a plurality of tabs of the upper end of the electrode;
expanding outwardly the plurality of tabs within the upper bore by the exertion of a downward force upon the expanding tool;
engaging outward sides of the plurality of tabs against an inner annular surface of the insulator thereby preventing downward movement of the electrode with respect to the insulator; and
retracting the expanding tool out of insulator.

15. The method of claim 14, further comprising the steps of:
depositing conductive glass into the insulator through the upper bore;
inserting a push pin into the insulator through the upper bore;
placing the granular conductive glass, the insulator, the push pin, and the electrode into a heat source;
melting the conductive glass seal;
removing the liquid conductive glass seal, the insulator, the push pin, and the electrode from the heat source; and
fusing the glass seal to the push pin and the electrode.

16. The method of claim 15 wherein:
the step of inserting the push pin further comprises disposing a push rod tool within the insulator above the push pin;
the placing step further comprises placing the push rod tool within the heat source along with the conductive glass, insulator, push pin, and insulator;
the removing step further comprises removing the push rod tool from the heat source along with the conductive glass, insulator, push pin, and insulator; and
the fusing step further comprises the steps of:
placing the insulator, the push pin, the electrode and the push rod tool into a press device,
moving the push rod tool down upon the push pin and the liquid seal,
positioning the push rod tool at a predetermined axial location within the insulator,
sustaining the push rod tool position until the seal envelops and hardens to the plurality of tabs of the electrode and a plurality of ribs of the push pin, and
removing the push rod tool upward through the upper bore.

17. The method of claim 16, further comprising the steps of:
inserting a spring and suppressor into the upper bore; and
securing a terminal into the upper bore such that the spring and suppressor form an electrical path from the push pin to the terminal with the spring being held by the terminal in compression.
